(19) United States
(12) Patent Application Publication
(10) Pub. No.: US 2026/0098441 A1
(43) Pub. Date: Apr. 9, 2026

(54) DEVICE FOR MOTORIZING A TILT FUNCTION OF WINDOW BLINDS AND A DRIVE SYSTEM

(71) Applicant: RYSE INC., Toronto (CA)

(72) Inventors: TRUNG DUC PHAM, TORONTO (CA); MARC BISHARA, TORONTO (CA); ARAS PUODZIUNAS, TORONTO (CA); MADISON POSLUNS, TORONTO (CA)

(21) Appl. No.: 19/351,778

(22) Filed: Oct. 7, 2025

Related U.S. Application Data
(60) Provisional application No. 63/705,310, filed on Oct. 9, 2024.

(51) Int. Cl. E06B 9/307

(52) U.S. Cl. CPC E06B 9/307

(57) ABSTRACT

A device for motorizing window blinds that are operated by wand or rod tilt mechanisms and, in particular, to a device that may be easily installed by users to motorize or automate the tilting function of the slats in window blinds while still enabling manual operation via the wand. The device is designed for compatibility and installation with existing blinds and to integrate with home automation systems and other applications. Also, a drive system for the above device.

This application claims the benefit of U.S. Provisional Appln. Serial No. 63/705,310, filed October 9, 2024, the entirety of which is incorporated by reference herein

### FIELD OF THE INVENTION

The present specification relates generally to a device to motorize window blinds, and more particularly to a device for the motorization of wand-operated window blinds.

### BACKGROUND OF THE INVENTION

Window blinds are commonly used as window coverings in both residential and commercial settings to control light and privacy. A common model of traditional blinds features a wand or rod that is manually rotated to tilt the slats of the blinds to adjust their angle between open and closed positions, as well as intermediate positions. It would be desirable to have a motorized and/or automated control for the adjustment of the slats in place of the traditional manual system.

Current motorized blind systems require either full replacement of the blinds or costly, complex installations. A further issue with these existing solutions is that they rarely offer the flexibility to maintain manual control of the blinds after motorization, nor do they provide easy DIY installation.

Therefore, a need exists for a retrofit device that allows users to motorize their existing blinds in a simple, user-friendly manner. This device should enable users to maintain manual control of the adjustment of the slats through the blinds existing wand/rod while also enabling motorization of the tilting process and enabling additional features such as automation, remote control and smart home integration.

Accordingly, there remains a need for improvements in the art.

### SUMMARY OF THE INVENTION

In an embodiment, there is provided a drive system for motorizing a tilt function of window blinds, comprising: a connector for attaching to a tilt mechanism of the window blinds; a clutch operatively connected to the connector, a tilt wand connector, and a motor, and a manual rotation of the tilt wand connector in either direction engages the clutch and rotates the connector for adjusting the tilt function and the motor simultaneously; and the motor operatively connected to the clutch, where a motorized rotation of the motor rotates the connector for adjusting the tilt function.

The drive system may further comprise encoder or encoders electronically connected to a microcontroller for detecting and measuring a rotation of the motor. The manual rotation of the tilt wand connector in either direction is transferred to the motor for measuring the rotation of the motor by the encoder; and the motorized rotation of the motor in either direction causes the rotation and the rotation is measured by the encoder.

In the drive system the motorized rotation of the motor in either direction may disengage the clutch from the tilt wand connector. The rotation of the motor measured by the encoder may correspond to a tilt adjustment of the tilt mechanism.

Any of the manual rotation, the motorized rotation, or both the manual rotation and the motorized rotation of the connector for adjusting the tilt adjustment may be measured by the encoder for tracking a position of the tilt adjustment.

Alternatively, or additionally, the position of the tilt adjustment is continuously tracked by the microcontroller through the encoder when there is the manual rotation, the motorized rotation, or both the manual rotation and the motorized rotation.

The clutch may comprise: a ball; an collar on a bottom surface, the collar for holding a ball and receiving a tilt wand connector head of the tilt wand connector, the tilt wand connector head having a flat surface for urging the ball, and a slot in the collar for allowing the ball to pass through; and an outer gear with a hollow interior, the hollow interior for receiving the collar, the hollow interior having an inner face with repeating spherical caps for receiving a portion of the ball, and the outer gear operatively connected to the connector.

In the clutch, the bottom surface may have an annular slope that descends towards a center of the bottom surface for urging the ball towards the center by gravity for disengaging the clutch; and the bottom surface may define a channel in the center for receiving at least a portion of the tilt wand connector, the tilt wand connector head, or both the tilt wand connector head and the tilt wand connector. The collar have a tongue for mating with a circular groove in the bottom surface.

In an embodiment, the manual rotation of the tilt wand connector causes the flat surface to urge the ball partially through the slot in the collar and into one of the spherical caps so that the manual rotation of the tilt wand connector is transferred to the outer gear for engaging the clutch.

In an embodiment, the motorized rotation of the motor causes the outer gear to rotate and urge the ball away from the spherical caps through the slot in the collar so that the motorized rotation is not transferred to the tilt wand connector for disengaging the clutch.

The manual rotation of the tilt wand connector may be measured by the encoder and may act as an input switch for triggering the motorized rotation of the motor.

In an embodiment, the connector may comprise an inner lining with flanges for gripping the tilt mechanism, an outer housing with an open end for receiving the inner lining, and the outer housing is operatively connected to the clutch.

In another embodiment, there is provided a device for motorizing a tilt function of window blinds, comprising: a connector for attaching to a tilt mechanism of the window blinds; a housing, the housing comprising: a microcontroller for controlling a motor, encoder for measuring a rotation of the motor, and the motor and the encoder electrically connected to the microcontroller; a clutch operatively connected to the connector, a tilt wand connector, and the motor, and manual rotation of the tilt wand connector in either direction engages the clutch for rotating the connector for adjusting the tilt function and the motor simultaneously; the motor operatively connected to the clutch, where a motorized rotation of the motor rotates the connector for adjusting the tilt function.

The manual rotation of the tilt wand connector in either direction is transferred to the motor for measuring the rotation of the motor by the encoder; and the motorized rotation of the motor in either direction causes the rotation and the rotation is measured by the encoder. The motorized rotation of the motor in either direction may disengage the clutch from the tilt wand connector

The device may further comprise a communications module for wireless communication and for remote operation of the device.

The device may still further comprise a battery, a solar charging module, or both a battery and a solar charging module for powering the device.

The device may still further comprise a mount for mounting the device on or near the window blinds.

In another embodiment, there is provided a device for motorizing a tilt function of window blinds, comprising: a microcontroller for controlling a motor, encoder for measuring a rotation of the motor, and the motor and the encoder electrically connected to the microcontroller; a connector for attaching to a tilt mechanism of the window blinds; the motor operatively connected to the connector and a motorized rotation of the motor rotates the connector for adjusting the tilt function; and wherein, the motorized rotation of the motor is measured by the encoder; and, the motorized rotation of the connector for adjusting the tilt function is measured by the encoder for tracking positions of the tilt function and the motor

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a front perspective view of the smart home device mounted to a set of window blinds according to an embodiment;

FIG. 2 is a close-up view of FIG. 1;

FIG. 3 is an isolated view of the motor housing and the electronics housing;

FIG. 4 is front perspective view according to FIG. 1 with an exploded view of the connector;

FIG. 5 is a perspective exploded view of the electronics housing;

FIG. 6A is a perspective exploded view of the motor housing;

FIG. 6B is a side view of FIG. 6A;

FIG. 7A is a closeup side view of the motor and tilt wand connector;

FIG. 7B is a top view of FIG. 7A;

FIG. 7C is a partial sectional view of FIG. 7A;

FIG. 7D is an exploded view of an embodiment of the clutch;

FIG. 7E is a perspective view of a portion of an embodiment of the clutch;

FIG. 8A is a sectional view of FIG. 7A with the clutch disengaged;

FIG. 8B is a sectional view of FIG. 7A at the start of the clutch engagement process;

FIG. 8C is a sectional view of FIG. 7A with the ball entering the spherical cap;

FIG. 8D is a sectional view of FIG. 7A with the clutch engaged;

FIG. 9A is a sectional view of FIG. 7A with the clutch engaged;

FIG. 9B is a sectional view of FIG. 7A at the start of the clutch disengagement process with the ball exiting the spherical cap;

FIG. 9C is a sectional view of FIG. 7A with the clutch partially disengaged;

FIG. 9D is a sectional view of FIG. 7A with the clutch disengaged;

FIG. 10 is a block diagram of the device according to an embodiment;

FIG. 11 is a block diagram of an embodiment of the FIG. 10;

FIG. 12 is an embodiment of motor calibration;

FIG. 13 is an embodiment of position control and back-drive of the motor;

FIG. 14 is a state machine on an implementation of Leunberger observer; and;

FIG. 15 is a set of graphs of the encoder measurements.

Like reference numerals indicated like or corresponding elements in the drawings.

### PARTS LIST:

100 – Device

105 – Mount

110 – Motor Housing

210 –Connector

212 – Inner Lining

213 – U-Joint

214 – Flanges

216 – Outer Housing

218 – Open End

240 – Motor

245 – Motor Microcontroller

250 – Clutch

230 – Tilt Wand Connector

235 – Tilt Wand Connector Head

238 – Flat surface

310 – Ball

320 – Collar

322 – Tongue

330 – Bottom Surface

332 – Groove

340 – Outer Gear

350 – Hollow Interior

360 – Inner Face

370 – Spherical Caps

380 – Annular Slope

390 – Slot

395 – Channel

255 – Encoder

265 – Motor Gear

120 – Electronics Housing

410 – Power Source

420 – Power connection

430 – Communication Connection

445 – Motor Driver

470 – Communications module

475 – H-Bridge

480 – Input

490 – Display

130 – Window Blind

135 – Tilt Mechanism

140 – Blind Slats

150 – Wand

### DETAILED DESCRIPTION OF THE EMBODIMENTS

The present invention relates to a device for motorizing window blinds that are operated by wand or rod tilt mechanisms and, in particular, to a device that can be easily installed by users to automate the tilting function of the slats in window blinds while still enabling manual operation via the wand. The device is designed for compatibility and installation with existing blinds and to integrate with home automation systems and other applications.

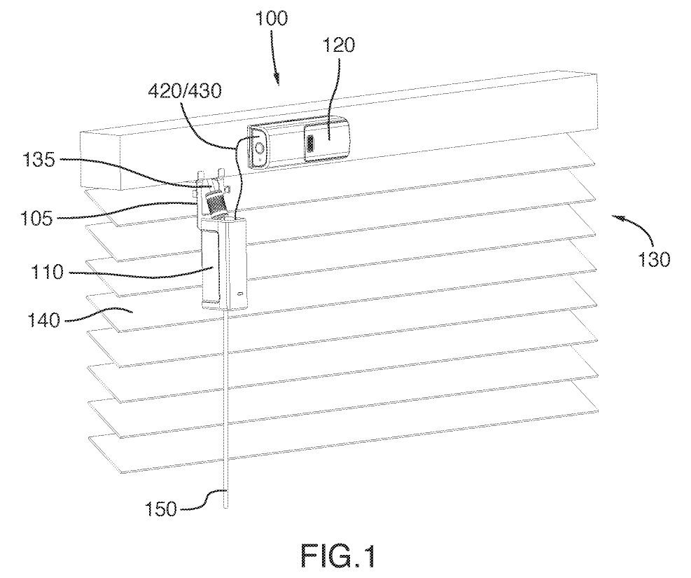

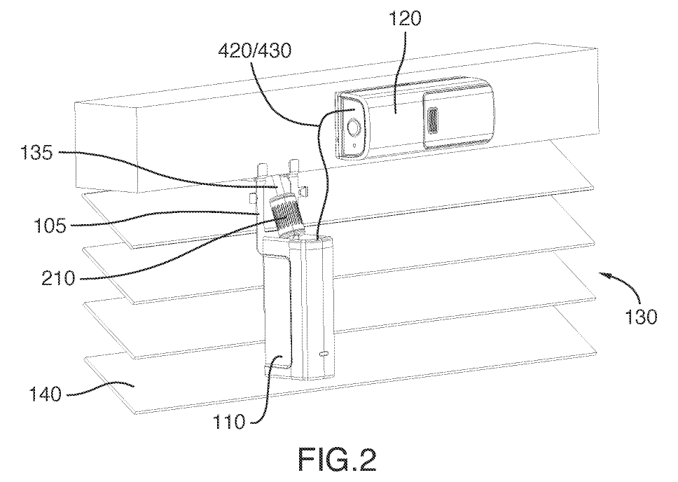

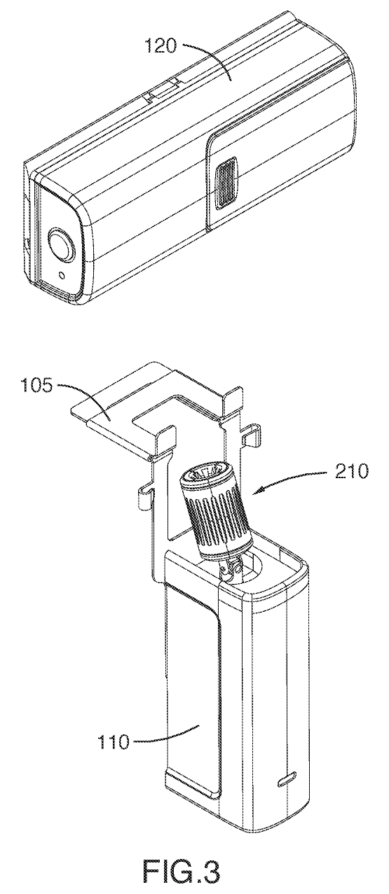

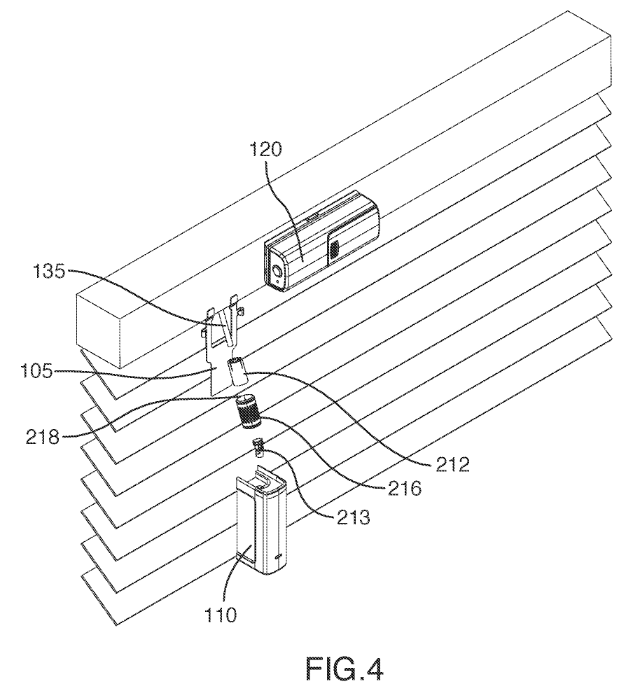

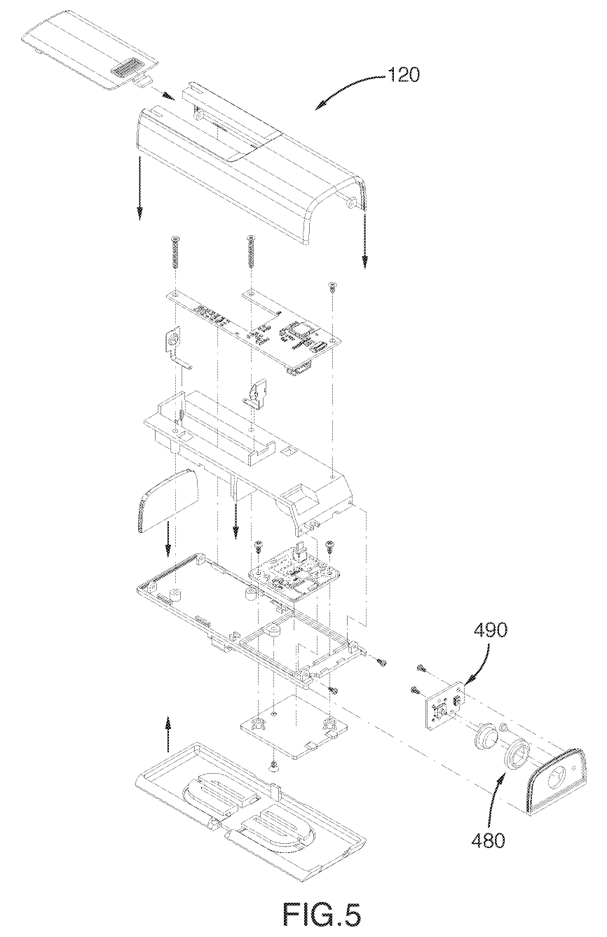

According to an embodiment as shown in FIGS. 1-4, device 100 is comprised of two main components, a motor housing 110 and an electronics housing 120. The motor housing 110 and the electronics housing 120 may be combined into a single unit or may be provided as separate units which may be physically and/or electronically coupled together. The motor housing 110 and electronics housing 120 are secured to the window blind via mount 105 and operatively connected to the tilt mechanism 135 of window blind 130 to provide for tilt adjustment of the blind slats 140. The housing or housings may be attached to the window blinds 130 or in the area of the window blinds by the mount 105 or other known methods such as adhesive tape. The mount 105 may also be adjustable to accommodate different types of window blinds 130. An exploded view of an embodiment of the electronic housing is shown in FIG. 5.

The motor housing 110 comprises a connector 210 which is secured to the tilt mechanism 135 of window blind 130. Motor housing 110 further comprises a tilt wand connector 230 which is coupled to the wand 150 which is operative to manually adjust the tilt of the blind slats 140. The wand 150 may be the existing wand used for the blinds 130.

Connector 210 has an inner lining 212 with flanges 214 for gripping tilt mechanism 135, and an outer housing 216 with an open end 218 for receiving inner lining 212. Connector 210 may be coupled or operatively connected to the clutch 250 in the motor housing 110 via a U-joint 213 or similar mechanism. The U-joint 213 permits adjustment of the angle of connection of the connector 210 to the tilt mechanism 135. The connector 210 can connect to a variety of shapes of tilt mechanism 135, such as rods with hole, hooks, and loops. The flanges 214 or ribs may be made of rubber, plastic or other material that can grip the tilt mechanism 135 during rotation of the connector 210.

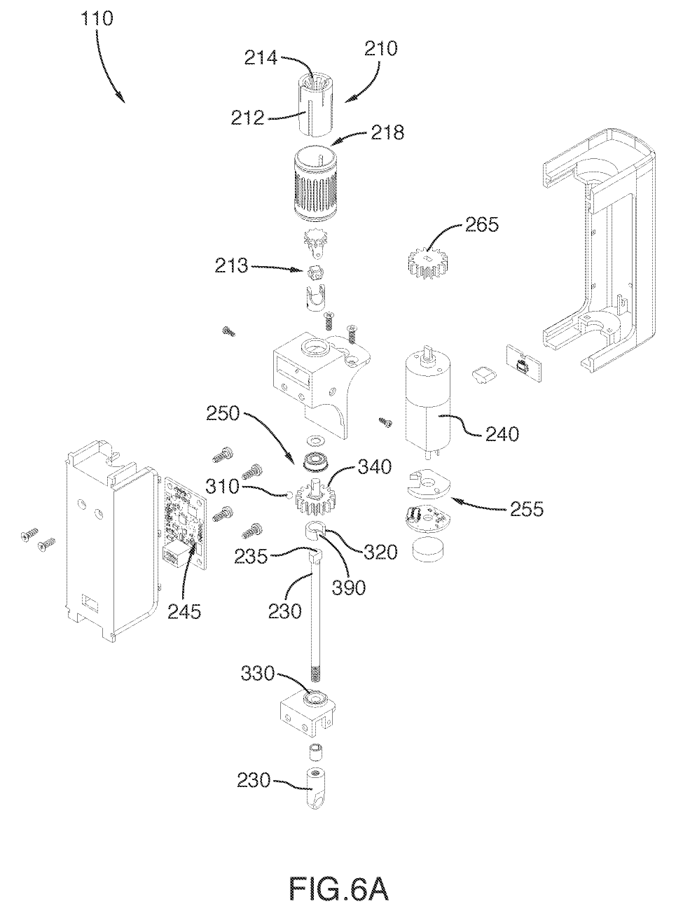

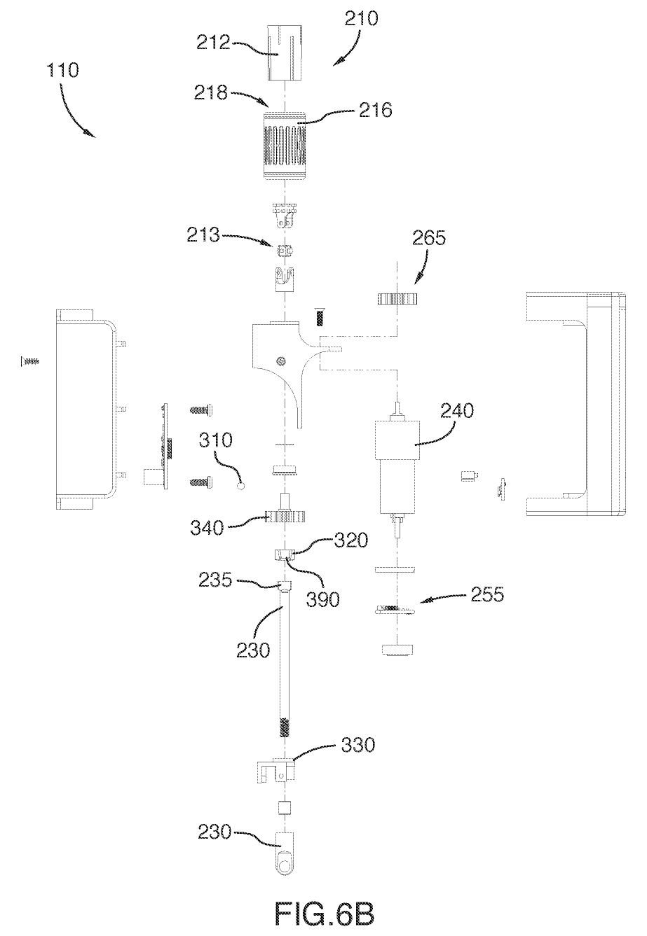

Referring to FIGS. 6A and 6B, in an embodiment, the motor housing 110 contains a motor 240, a clutch 250 which is operatively connected to the motor 240 via motor gear 265, as well as to outer housing 216 of connector 210 and to tilt wand connector 230. Motor 240 is operatively connected to a motor microcontroller 245 and an encoder 255. Motor microcontroller 245 provides operative control of motor 240. Encoder 255 measures and provides information related to the operation of the motor 240 to the motor microcontroller 245 for tracking positional information of the connector 210 and/or tilt mechanism 135. Recall, the tilt mechanism 135 is rotated by the connector 210. The positional information of the connector 210 and/or the tilt mechanism 135 may correspond with or may be translated into positional tracking of the blind slats 140. The measured information by the encoder 255 of the motor 240 may be the direction of rotation, the amount of rotation, speed of rotation, and/or position of rotation of the motor 240. A skilled person would understand that the encoder 255 may also be implemented using Hall effect sensors, magnets, counting ripples generated by the operation of the motor, and other known techniques. In an embodiment the motor 240 is a DC motor, and the encoder 255 is compatible with the DC motor.

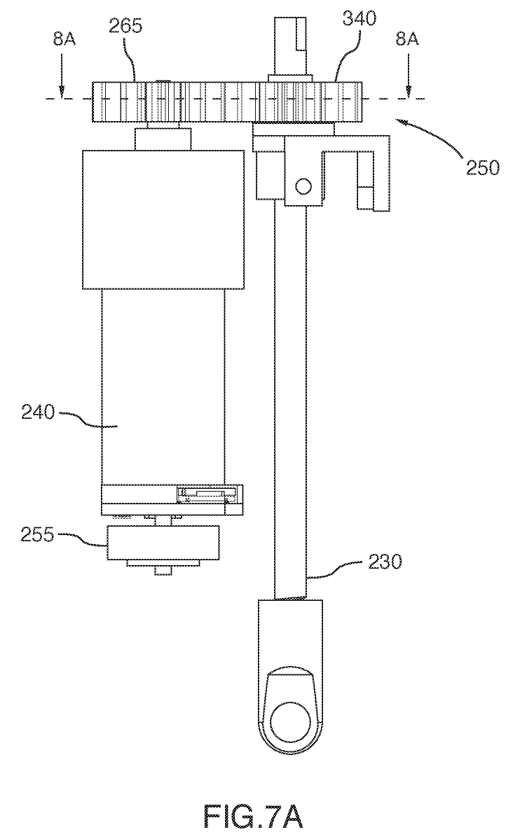

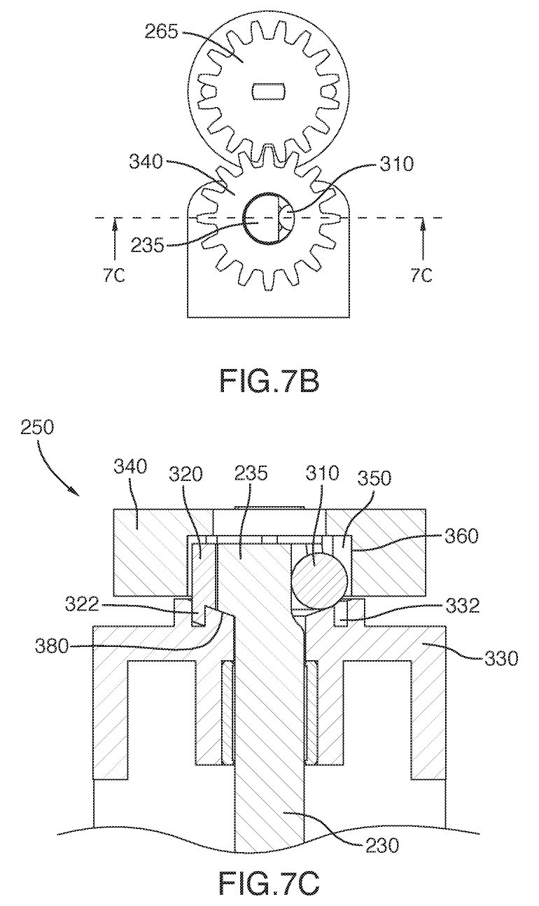

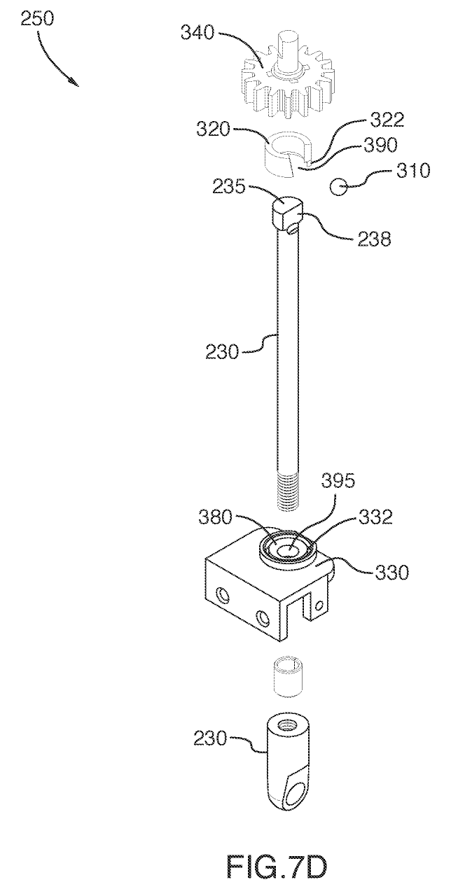

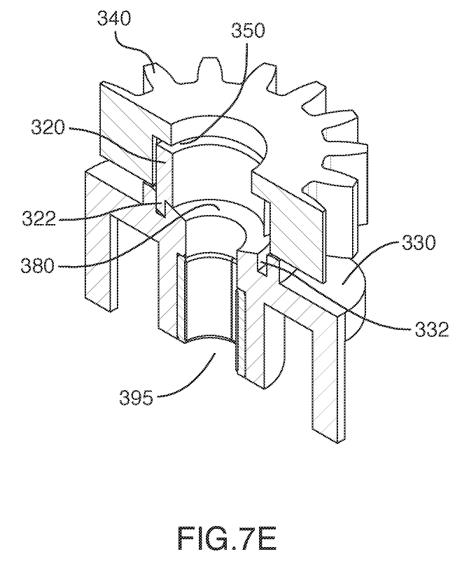

Referring also to FIGS. 7A to 7E, in an embodiment, the clutch 250 is formed from a ball 310, tilt wand connector head 235, and a collar 320 with a bottom surface 330. Where the collar 320 holds the ball 310 and the tilt wand connector head 235 within. Clutch 250 further comprises an outer gear 340 with a hollow interior 350 for receiving collar 320. Outer gear 340 is further operatively connected to connector 210 and to motor 240 by motor gear 265. Hollow interior 350 has an inner face 360 with repeating spherical caps 370 which are dimensioned to receive a portion of ball 310. Collar 320 has a slot 390 which enables ball 310 to pass through and engage one of the spherical caps 370 in outer gear 340. In an embodiment, bottom surface 330 may be formed with an annular slope 380 descending towards the center of the bottom surface 330 such that ball 310 is urged towards the center by the force of gravity to disengage the clutch 250. The bottom surface may also define a hole or a channel 395 in the center of the bottom surface for allowing the tilt wand connector to pass through and/or the tilt wand connector head. The center may be defined as the center of the collar 320, as the collar 320 rests on the bottom surface 330. As shown in FIGS. 7C to 7E, collar 320 may be formed with a tongue 322 which engages a groove 332 in bottom surface 330 to rotably align collar 320 to bottom surface 330. The collar 320 is rotable on the surface of bottom surface 330.

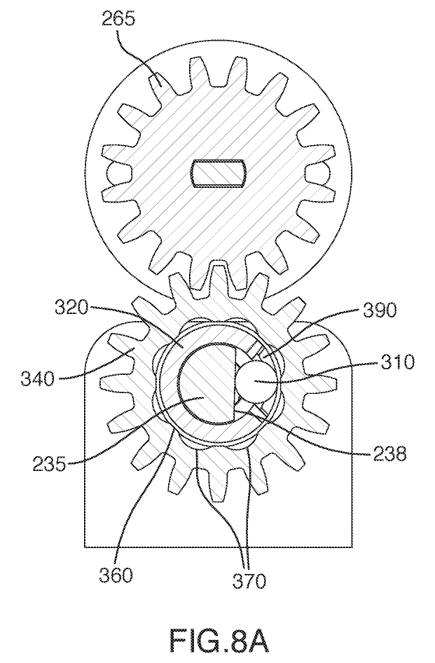

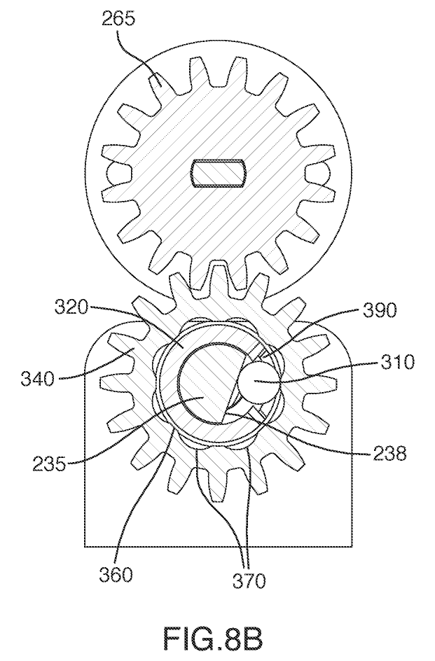

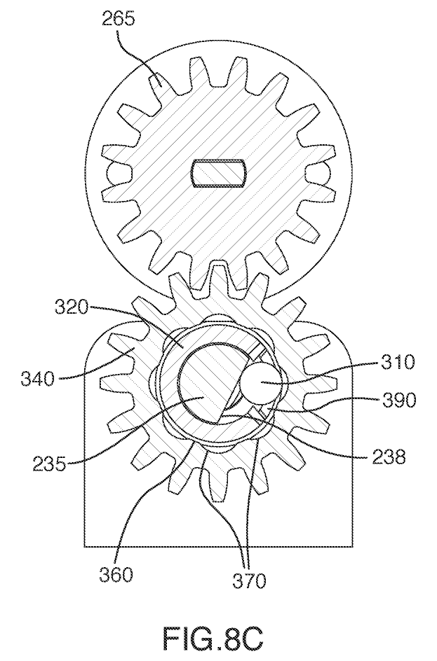

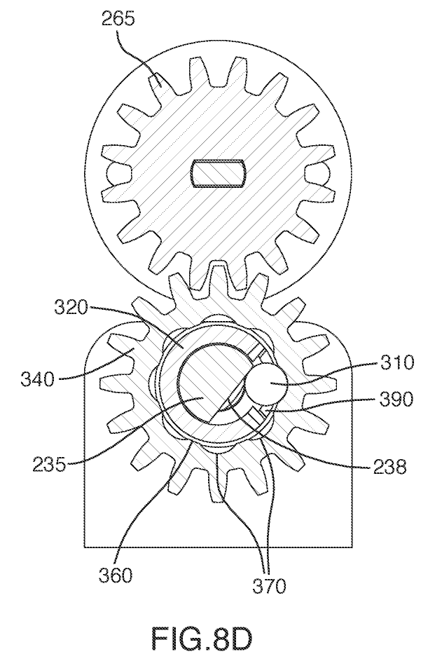

In operation, referring to FIGS. 8A-8D, the tilt wand connector head 235 of tilt wand connector 230 has a flat surface 238 which contacts and engages with ball 310. When wand 150 is rotated, tilt wand connector 230 and tilt wand connector head 235 rotate and flat surface 238 urges ball 310 further through slot 390 which results in ball 310 engaging into one of spherical caps 370. Accordingly, once ball 310 is positioned in one of spherical caps 370, clutch 250 is engaged such that the manual rotation of wand 150 is then transferred to outer gear 340 through tilt wand connector 230 and the ball 310. The clutch 250 is operable in either direction, that is clockwise or counterclockwise rotation of the tilt wand connector head 235.

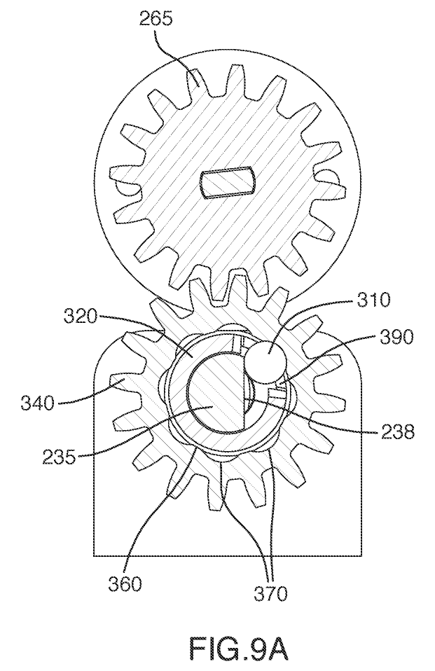

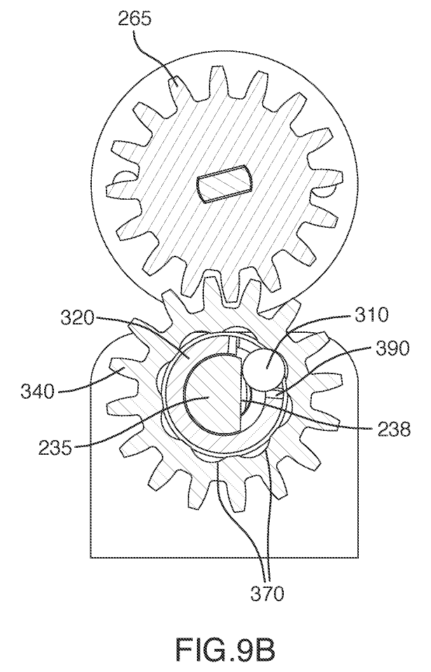

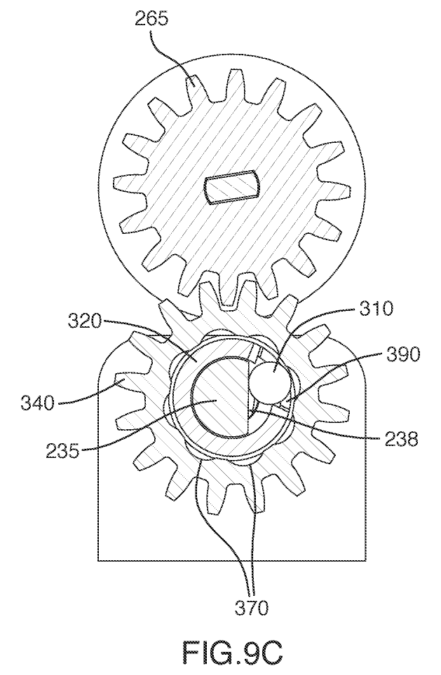

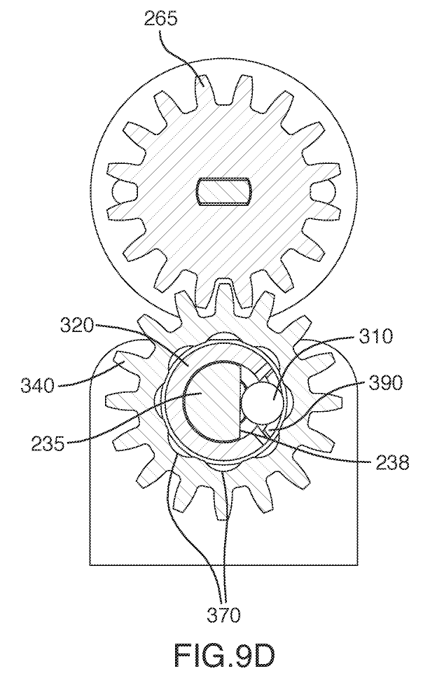

In an embodiment, referring to FIGS. 9A-9D, in motorized rotation, motor 240 drives rotation of outer gear 340 through motor gear 265. The rotation of outer gear 340 results in ball 310 being urged out of spherical cap 370 by the inner face 360 partially through the slot 390 into collar 320. Clutch 250 is thus disengaged and the motorized rotation of outer gear 340 rotates the connector 210 for rotating the tilt mechanism 135. When the clutch 250 is disengaged, the motorized rotation of the outer gear 340 happens without the rotational motion being transferred to tilt wand connector head 235 and tilt wand connector 230. Thus, the motorized rotation is also not transferred to wand 150. The clutch 250 may be disengaged by clockwise or counterclockwise motorized rotation of the outer gear 340.

In an embodiment, accordingly, in manual operation, manual rotation of the wand 150 engages clutch 250 and rotates connector 210 to enable manual adjustment of the tilt angle of blind slats 140. Furthermore, in manual operation, the motor 240 is also rotated by the outer gear 340 via the motor gear 265. In motorized operation, rotation of motor 240 disengages clutch 250 from wand 150, and rotates connector 210 to enable motorized adjustment of the tilt angle of blind slats 140. In both manual rotation and/or motorized rotation the motor 240 is rotated. Therefore, the encoder 255 may measure the rotation and/or operation of the motor 240. The motor microcontroller 245 may then track rotation of the connector 210 and/or the tilt mechanism 135 by receiving signals from the encoder 255. The motor microcontroller 245 may also calculate a position of the blind slats 140 from the rotational position of the connector 210 and/or the tilt mechanism 135. In another embodiment, the position of the connector 210 and/or the tilt mechanism 135 is used as a proxy for the position of the blind slats 140 of the window blind 130.

In an alternate embodiment, clutch 250 may remain engaged during both the manual and the motorized operations, such that the tilt wand connector 230 and/or the wand 150 will rotate with the motorized rotation of motor 240. In a further embodiment, motor 240 may be directly operatively coupled to connector 210 without any intervening clutch 250 and/or tilt wand connector 230. In a further embodiment, motor 240 may be directly operatively coupled to connector 210 without any intervening clutch 250

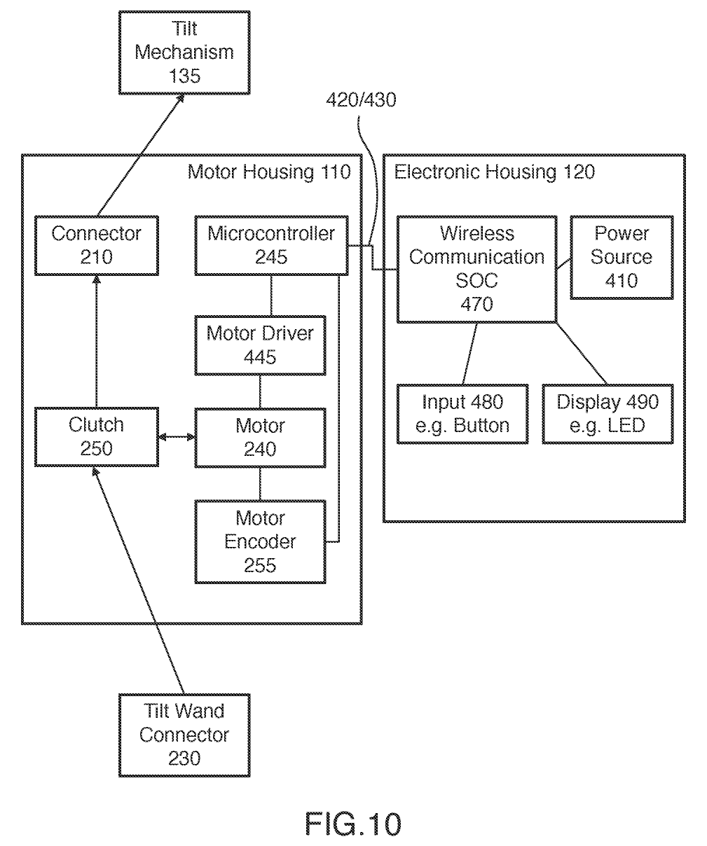

As shown in FIG. 10, motor housing 110 further contains a motor microcontroller 245 operably connected to motor 240 via a motor driver 445. In an embodiment, the motor driver 445 is an H Bridge 475. Motor microcontroller 245 is further operably connected to an encoder 255 for tracking and recording the position and direction of movement of motor 240. In an embodiment, the encoder 255 use a Hall effect sensor. A skilled person would understand that a variety of known motor drivers and encoders may be used.

Electronics housing 120 comprises a power source 410 (e.g. removable, rechargeable or fixed batteries, solar panels, an external power cable, or combinations thereof), a power connection 420 to motor housing 110, and a communication connection 430 (wired or wireless) to motor housing 110. In an embodiment, the power connection 420 and the communication 430 are a single cable (e.g. a USB-C connection).

Electronics housing 120 further comprises a wireless communication module 470 operative to receive communications and instructions for operation of motor 240 via a communications protocol (e.g. Z-WAVE, ZIGBEE, BLUETOOTH, WI-FI, UHF, infrared) from a remote device, remote application, or remote control. Electronics housing 120 may further comprise manual controls 480 (e.g. buttons, switches, toggles, etc.). The manual controls 480 may be used for powering on and off the device and/or activation of motor 240. Electronics housing 120 may further include displays 490 (e.g. LED light, segmented display, digital display, etc.) to indicate status (e.g. power, status, errors). In an embodiment, the communication module 470 may be a wireless system on chip (SOC) with both processor and radio. The motor microcontroller 245 may be a microcontroller. In another embodiment the communication module 470 and motor microcontroller 245 may be a single chip or microcontroller.

The encoder 255 is used to determine the direction and the amount of rotation of the motor 240. The motor microcontroller 245 may track the full open and full closed position of the blind slats 140 and is calibrated via a setup process when installing the device as discussed below. A skilled person understands that window blinds 130 have the blinds slats 140 in a closed up position, a closed down position, and an open position.

Communications module 470 enables the device 100 to receive instructions to set the blind 130 to be open, closed (up or down), or percentages of openness between 0-100%. Instructions may be programmed, sent directly from an application (e.g. mobile device application or computer device application), or sent from a smart home control system (e.g. AMAZON ALEXA, GOOGLE HOME, APPLE HOMEKIT). These same systems may enable additional features such as voice control. FIG. 5 shows an embodiment of the electronics housing 120.

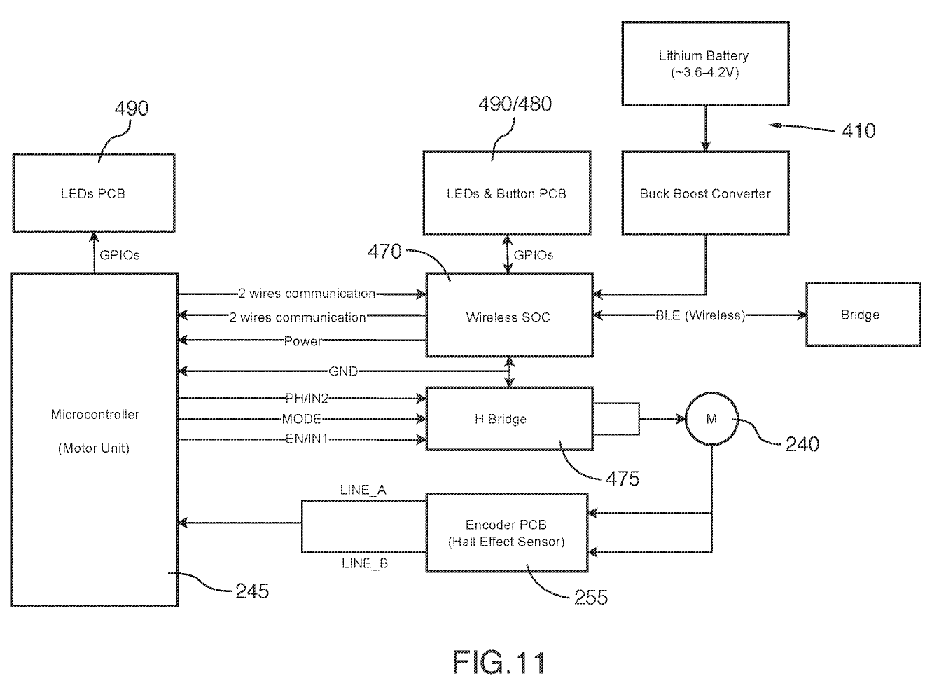

Referring to FIG. 11, in an embodiment, power source 410 is a single lithium battery, and communications module 470 is a wireless system-on-chip (SOC). SOC 470 communicates with motor microcontroller 245 and with motor 240 via an H-Bridge 475. In an embodiment, the encoder 255 uses Hall Effect Sensors. The encoder 255 send signals as quadrature encoder signals to motor microcontroller 245. These signals are processed to determine the target position, define the calibration range, and estimate the presence of obstacles. The motor microcontroller 245 interfaces with the H-Bridge 475 to drive the motor 240. Communication between the SOC 470 and the motor microcontroller 245 may be established via UART or I²C, with support for multiple devices if required. The SOC 470 may manage connectivity with a bridge and ensure integration within the smart device ecosystem and applications.

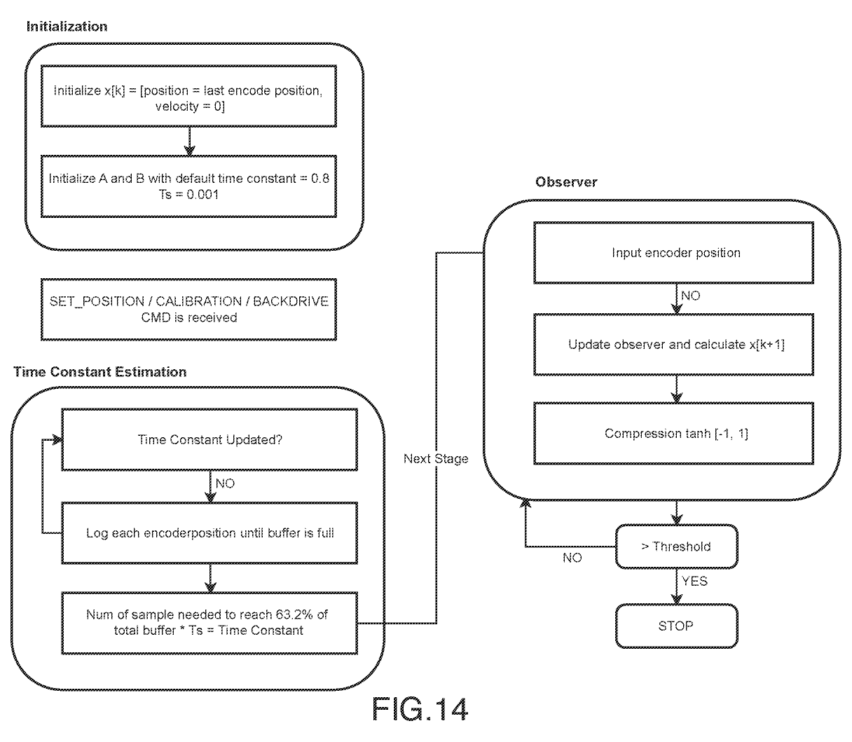

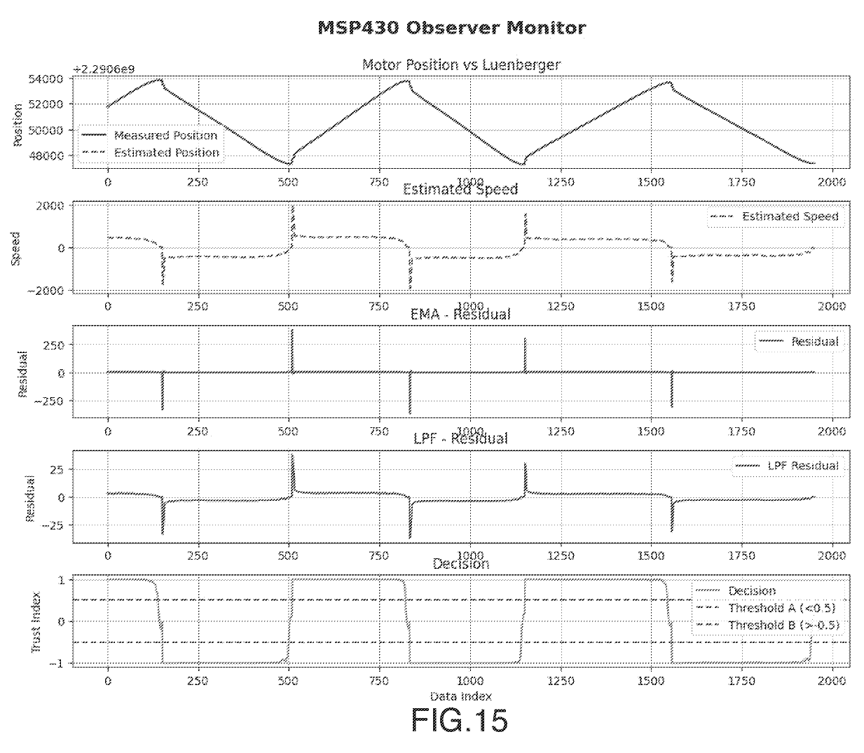

In an embodiment, obstacle detection by estimating system states may be implemented on the microcontroller 240 as a Luenberger Observer model. In an embodiment, quadrature signals are the only signals used to represent motor status. The state vector at time step k models position and velocity. An embodiment of the implementation is shown in FIG. 14. For detecting obstacles, the first derivative of the smoothed residual is used. When there is no obstacle, the derivative is close to zero. When there is an obstacle, a spike is expected. The exponential moving average is used to smooth the output. To compress the decision in [-1, +1] a tanh function is used. Updating the estimated speed is done using a low-pass filter (LPF). FIG. 15 illustrates the graphical relationship of the above observer monitor. The Motor Position vs Luenberger, Estimated Speed, EMA - residual, LPF – residual, and Decision is shown. A skilled person understand that other motor obstacle detection models may be used, such as the measurement of a current spike. An advantage of the above Luenberger Observer model embodiment is that no current measurement sensor and/or voltage measurement sensor is required.

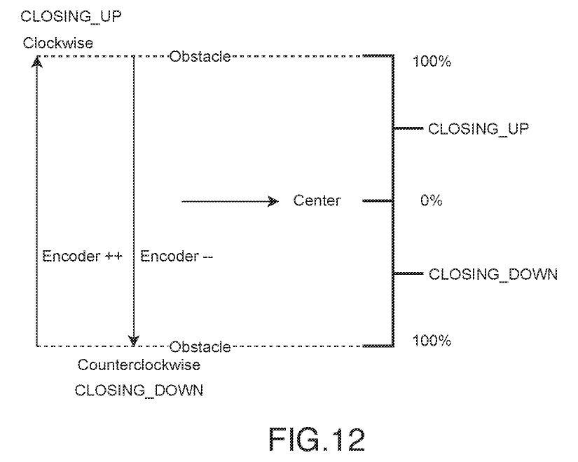

In an embodiment, referring to FIG. 12, motor calibration is performed in the following steps: motor 240 rotates in a first direction (e.g. clockwise direction) and saves the position until obstacle detection is triggered. Motor rotates in a second direction (e.g. counterclockwise direction) and saves the position until obstacle detection is triggered. The first direction is designated as either CLOSING UP state or CLOSING DOWN state, and the second direction is designated as the other state. User input may be required to map the first direction to either CLOSING UP or CLOSING DOWN state that matches the tilt of the blind slats 140 of the window blinds 130. The center position is set, that is, the default center position is center of CLOSING UP + CLOSING DOWN. All subsequent position commands preferably remain within the calibrated limits. In another embodiment, the user uses manual rotation and/or motorized rotation to set a first direction boundary to CLOSING UP or CLOSING DOWN state. Then the user uses manual rotation and/or motorized rotation to set the second direction boundary and the other state. A skilled person would understand that if one boundary is the CLOSING UP state then the other boundary is the CLOSING DOWN state, and vice versa.

In an embodiment, clockwise and counterclockwise directions are automatically determined by the firmware on motor microcontroller 245. Upon initial firmware load, a motor test generates a truth table that links encoder 255 changes, motor driver 445 logic, and the corresponding motor directions.

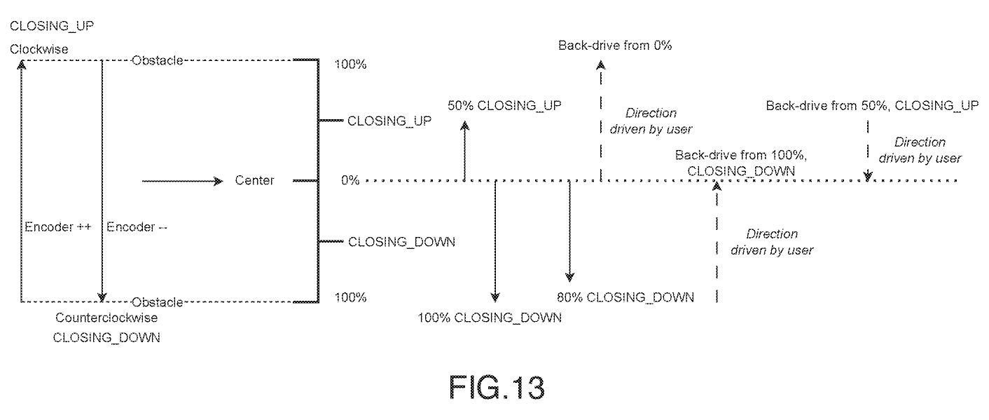

Referring to FIG. 13, for position control, in an embodiment, the software application transmits a command to the communication module 470 specifying a target position as a percentage, along with a movement direction (defined as either CLOSING UP or CLOSING DOWN). This command is subsequently forwarded to the motor microcontroller 235, which calculates the corresponding target position and drives the motor 240 to achieve it. Concurrently, the obstacle detection system continuously monitors the operation to safeguard both the motor 240 and the window blind 130. Upon detection of an obstacle, the operation of motor 240 may be halted immediately. A notification may be sent to communications module 470, for example, to enable a user alert or indicate a status.

In another embodiment, an additional feature, referred to as back-drive, is activated when the user manually attempts to adjust the motor 240 position (e.g. using wand 150). Upon detecting such an action, the motor microcontroller 235 initiates motor movement in the intended direction. If the current position is at the CENTER, the motor 240 moves toward either CLOSING DOWN or CLOSING UP, depending on the back-drive direction. If the motor 240 is at either the CLOSING DOWN or CLOSING UP positions, it returns to the CENTER. For all other positions, the motor 240 moves toward CLOSING DOWN or CLOSING UP based on the back-drive direction. In a further embodiment, the manual rotation is interpreted by the motor microcontroller 235 as an input causing motorized rotation in the direction of the manual rotation.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the patent office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

1. A drive system for motorizing a tilt function of window blinds, comprising:
a connector for attaching to a tilt mechanism of the window blinds;
a clutch operatively connected to the connector, a tilt wand connector, and a motor, and a manual rotation of the tilt wand connector in either direction engages the clutch and rotates the connector for adjusting the tilt function and the motor simultaneously; and
the motor operatively connected to the clutch, where a motorized rotation of the motor rotates the connector for adjusting the tilt function.

2. The drive system of claim 1, further comprising:
an encoder electronically connected to a microcontroller for detecting and measuring a rotation of the motor; and,
wherein,
the manual rotation of the tilt wand connector in either direction is transferred to the motor for measuring the rotation of the motor by the encoder; and
the motorized rotation of the motor in either direction causes the rotation and the rotation is measured by the encoder.

3. The drive system of claim 1, further wherein:
the motorized rotation of the motor in either direction disengages the clutch from the tilt wand connector.

4. The drive system of claim 1, further wherein:
the rotation of the motor measured by the encoder corresponds to a tilt adjustment of the tilt mechanism.

5. The drive system of claim 1, further wherein:
the manual rotation, the motorized rotation, or both the manual rotation and the motorized rotation of the connector for adjusting the tilt adjustment is measured by the encoder for tracking a position of the tilt adjustment.

6. The drive system of claim 1, further wherein:
the position of the tilt adjustment is continuously tracked by the microcontroller through the encoder when there is the manual rotation, the motorized rotation, or both the manual rotation and the motorized rotation.

7. The drive system of claim 1, wherein the clutch comprises:
a ball;
an collar on a bottom surface, the collar for holding a ball and receiving a tilt wand connector head of the tilt wand connector, the tilt wand connector head having a flat surface for urging the ball, and a slot in the collar for allowing the ball to pass through;
an outer gear with a hollow interior, the hollow interior for receiving the collar, the hollow interior having an inner face with repeating spherical caps for receiving a portion of the ball, and the outer gear operatively connected to the connector.

8. The drive system of claim 7, wherein the clutch further comprises:
the bottom surface having an annular slope that descends towards a center of the bottom surface for urging the ball towards the center by gravity for disengaging the clutch.

9. The drive system of claim 8, wherein the clutch further comprises:
the bottom surface defining a channel in the center for receiving at least a portion of the tilt wand connector, the tilt wand connector head, or both the tilt wand connector head and the tilt wand connector; and
the collar having a tongue for mating with a circular groove in the bottom surface.

10. The drive system of claim 7, wherein:
the manual rotation of the tilt wand connector causes the flat surface to urge the ball partially through the slot in the collar and into one of the spherical caps so that the manual rotation of the tilt wand connector is transferred to the outer gear for engaging the clutch.

11. The drive system of claim 7, wherein:
the motorized rotation of the motor causes the outer gear to rotate and urge the ball away from the spherical caps through the slot in the collar so that the motorized rotation is not transferred to the tilt wand connector for disengaging the clutch.

12. The drive system of claim 1, wherein:
the manual rotation of the tilt wand connector is measured by the encoder and acts as an input switch for triggering the motorized rotation of the motor.

13. The drive system of claim 1, wherein the connector comprises an inner lining with flanges for gripping the tilt mechanism, an outer housing with an open end for receiving the inner lining, and the outer housing is operatively connected to the clutch.

14. A device for motorizing a tilt function of window blinds, comprising:
a connector for attaching to a tilt mechanism of the window blinds;
a housing, the housing comprising:
a microcontroller for controlling a motor, an encoder for measuring a rotation of the motor, and the motor and the encoder electrically connected to the microcontroller;
a clutch operatively connected to the connector, a tilt wand connector, and the motor, and manual rotation of the tilt wand connector in either direction engages the clutch for rotating the connector for adjusting the tilt function and the motor simultaneously;
the motor operatively connected to the clutch, where a motorized rotation of the motor rotates the connector for adjusting the tilt function.

15. The device of claim 14, wherein:
the manual rotation of the tilt wand connector in either direction is transferred to the motor for measuring the rotation of the motor by the encoder; and
the motorized rotation of the motor in either direction causes the rotation and the rotation is measured by the encoder.

16. The device of claim 14, further wherein:
the motorized rotation of the motor in either direction disengages the clutch from the tilt wand connector.

17. The device of claim 14, further comprising:
a communications module for wireless communication and for remote operation of the device.

18. The device of claim 14, further comprising:
a battery, a solar charging module, or both a battery and a solar charging module for powering the device.

19. The device of claims claim 14, further comprising:
a mount for mounting the device on or near the window blinds.

20. A device for motorizing a tilt function of window blinds, comprising:
a microcontroller for controlling a motor, an encoder for measuring a rotation of the motor, and the motor and the encoder electrically connected to the microcontroller;
a connector for attaching to a tilt mechanism of the window blinds;
the motor operatively connected to the connector and a motorized rotation of the motor rotates the connector for adjusting the tilt function; and
wherein,
the motorized rotation of the motor is measured by the encoder; and,
the motorized rotation of the connector for adjusting the tilt function is measured by the encoder for tracking positions of the tilt function and the motor.
